(19) United States
(12) Patent Application Publication
(10) Pub. No.: US 2005/0048968 A1
(43) Pub. Date: Mar. 3, 2005

(54) Wireless communication system with a supplemental communication sub-system

(76) Inventor: Martin Haueis, Jena (DE)

Correspondence Address: MENDELSOHN AND ASSOCIATES PC, 1515 MARKET STREET, SUITE 715, PHILADELPHIA, PA, 19102, US

(21) Appl. No.: 10/651,185

(22) Filed: Aug. 28, 2003

(51) Int. Cl. H04Q 7/20; H04M 11/00

(52) U.S. Cl. 455/426.1; 455/403

(57) ABSTRACT

A wireless communication system having primary and supplemental communication sub-systems. The primary communication sub-system includes a plurality of base stations and a mobile services switching center (MSC) of the prior art. The supplemental communication sub-system includes one or more supplemental transceiver units (STUs) controlled by a supplemental switching center (SSC) having access to a public switched telephone network. Each STU has a primary function and, in addition, is adapted to support (i) a wireless communication link with at least one mobile station and (ii) a wire-line communication link with the SSC. In one embodiment, an STU of the invention has a conventional TV receiver and a TV screen whose primary function is to receive and display television programs supplied over a cable network. In addition, the STU has an RF transceiver designed to support a wireless communication link with N mobile stations and an interface designed to support, over the same cable network used for transmitting the television signals, a cable communication link with a service distribution node of the cable service provider, which node is configured to perform the functions of an SSC.

### BACKGROUND OF THE INVENTION

1. Field of the Invention

The present invention relates to wireless communication systems.

2. Description of the Related Art

Wireless communication systems are extensively used to provide communication services to a wide array of users. A typical wireless communication system includes a plurality of base stations (BSs), each BS configured to communicate with mobile stations located in proximity to that BS. Base stations are appropriately spaced to create a communication structure, in which each BS covers a certain geographical area (cell). A typical BS has an antenna system coupled to a radio frequency (RF) transceiver to provide wireless links with mobile stations. In addition, each BS has an interface system to provide a wire-line link with a mobile services switching center (MSC). The MSC controls the operation of base stations in the assigned area and serves as a gateway between those base stations and the public switched telephone network (PSTN).

Actual shapes and sizes of cells in the communication structure are complex functions of the transmitted RF power, the terrain, the man-made environment, and the required quality of communication and user capacity. As a result, relatively often, a cell has a non-contractible shape characterized by the presence of one or more blind spots, i.e., locations at which service is (temporarily or permanently) unavailable to user (where the term “contractible” is a term of topological arts meaning “shrinkable to a point within itself”). For example, blind spots are often present in building interiors due to the substantial RF power attenuation by metal parts in the building structure.

### SUMMARY OF THE INVENTION

Problems in the prior art are addressed, in accordance with the principles of the present invention, by a wireless communication system having primary and supplemental communication sub-systems. The primary communication sub-system includes a plurality of base stations and a mobile services switching center (MSC) of the prior art. The supplemental communication sub-system includes one or more supplemental transceiver units (STUs) controlled by a supplemental switching center (SSC) having access to a public switched telephone network (PSTN). Each STU has a primary function and, in addition, is adapted to support (i) a wireless communication link with at least one mobile station and (ii) a wire-line communication link with the SSC. In one embodiment, an STU of the invention has a conventional TV receiver and a TV screen whose primary function is to receive and display television programs supplied over a cable network. In addition, the STU has an RF transceiver designed to support a wireless communication link with N mobile stations and an interface designed to support, over the same cable network used for transmitting the television signals, a cable communication link with a service distribution node of the cable service provider, which node is configured to perform the functions of an SSC. Advantageously, a wireless communication system of the invention may have a smaller area affected by blind spots compared to that in prior-art systems. In addition, the supplemental communication sub-system provides additional communication capacity, which may be utilized to improve performance, for example, when call volume processed by the primary communication sub-system becomes relatively high.

According to one embodiment, the present invention is a method of transmitting communication signals corresponding to a mobile station in a wireless communication system, the method comprising: (A) selecting one of a primary communication sub-system and a supplemental communication sub-system to carry the communication signals for the mobile station; and (B) transmitting the communication signals for the mobile station via the selected communication sub-system, wherein: the wireless communication system includes the primary and supplemental communication sub-systems; the supplemental communication sub-system includes one or more STUs connected to an SSC; the SSC has access to a PSTN and is adapted to control operation of the one or more STUs; and each STU has a primary function and is further adapted to support (i) a wireless communication link with at least one mobile station and (ii) a wire-line communication link with the SSC.

According to another embodiment, the present invention is an apparatus for use in a wireless communication system providing service to mobile stations, the apparatus comprising: a radio-frequency transceiver (RFT) adapted to support a wireless communication link with at least one mobile station; and an interface adapted to support a wire-line communication link with an SSC having access to a PSTN, wherein: the apparatus has a primary function and is adapted to be controlled by the SSC; and the wireless communication system includes the SSC.

### BRIEF DESCRIPTION OF THE DRAWINGS

FIG. 1 shows a diagram of a prior-art wireless communication system;

FIG. 2 shows a diagram of a wireless communication system according to one embodiment of the present invention; and

FIG. 3 shows a block diagram of a supplemental transceiver unit (STU) that can be used in the system of FIG. 2 according to one embodiment of the present invention.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

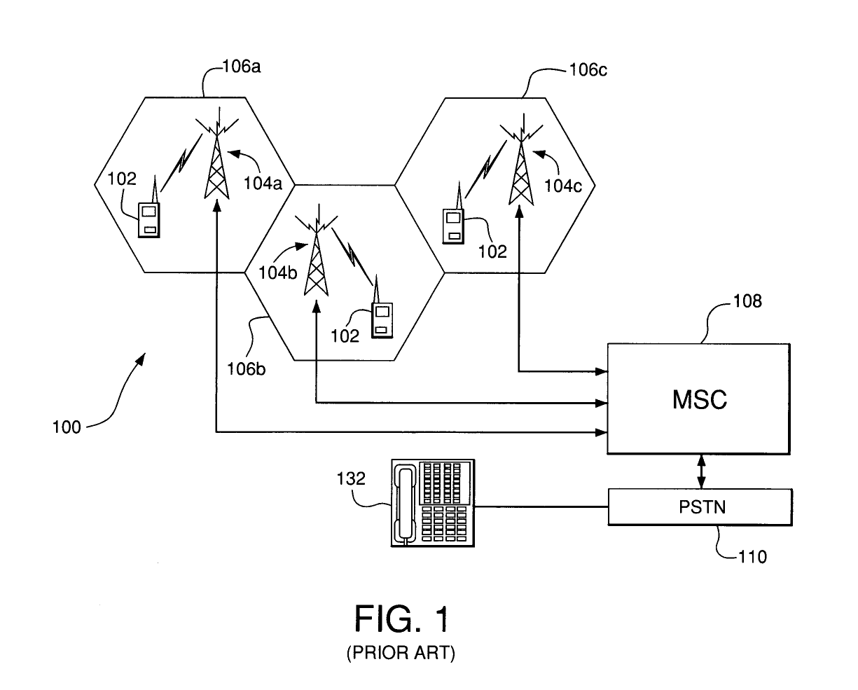

FIG. 1 shows a diagram of a prior-art wireless communication system 100. More specifically, system 100 includes a plurality of base stations 104 communicating with one or more mobile stations 102. Each base station (BS) 104 serves a cell 106 illustratively indicated in FIG. 1 by a hexagon. BS 104 is designed to provide (i) wireless links with mobile stations located within cell 106 and (ii) a wire-line link with a mobile services switching center (MSC) 108. MSC 108 is designed to control the operation of base stations 104 connected to the MSC. For example, MSC 108 provides the functions needed to track and maintain communication with each mobile station (MS) 102, including registration, authentication, location updating, hand-offs, call routing, etc. In addition, MSC 108 serves as a gateway to a public switched telephone network (PSTN) 110. Although only three cells 106a-c served by the corresponding three base stations 104a-c are shown in FIG. 1, wireless communication system 100 may include hundreds of cells 106 served by a corresponding number of base stations 104 and more than one MSC 108.

When a particular MS 102 is turned on or has just moved into the area served by system 100, that MS transmits a registration request containing its identification information. If a single BS 104 detects the registration request, that particular BS is assigned by MSC 108 to handle transmissions for MS 102. If more than one BS 104 detects the registration request, MSC 108 selects one particular BS, e.g., based on the detected signal strength, to handle those transmissions. When MS 102 moves within the coverage area of system 100, the MS may re-register as known in the art and a different BS 104 may be assigned by MSC 108 to handle transmissions for the MS.

The following is a brief description of representative steps taking place when MS 102 places or receives a call over system 100. When MS 102 attempts to place a call to a telephone 132 connected to PSTN 110, the MS sends a call initiation request containing the telephone number of telephone 132 to the corresponding BS 104. BS 104 forwards the request to MSC 108, which validates the request and uses the telephone number to make a connection via PSTN 108 to telephone 132. To receive incoming calls, MS 102 continually scans for paging signals from the corresponding BS 104. When MSC 108 receives via PSTN 110 a request from telephone 132 for connection with MS 102, the MSC forwards the request to the appropriate BS 104, which then pages the MS. After MS 102 acknowledges the page, MSC 108 routes the call from telephone 132 via the corresponding BS 104 to the MS.

To connect two mobile stations 102, MSC 108 receives, e.g., as described above, a request from a first (i.e., calling) MS 102. When the requested (i.e., called) MS 102 is located in the area controlled by MSC 108, the MSC routes the call to that MS, e.g., as described above, but without connecting to PSTN 110. However, when the called MS is located in the area controlled by a different MSC, MSC 108 connects to that other MSC via PSTN 110. The MSC corresponding to the called MS then routes the call to that MS, e.g., as already described above for a call originating from telephone 132.

As indicated in the background section, one problem with system 100 is that each cell 106 might have one or more blind spots, e.g., inside buildings, where signals from the corresponding BS 104 are substantially blocked from reaching mobile stations located within those blind spots. It is therefore desirable to have a wireless communication system, in which the occurrence of blind spots is reduced.

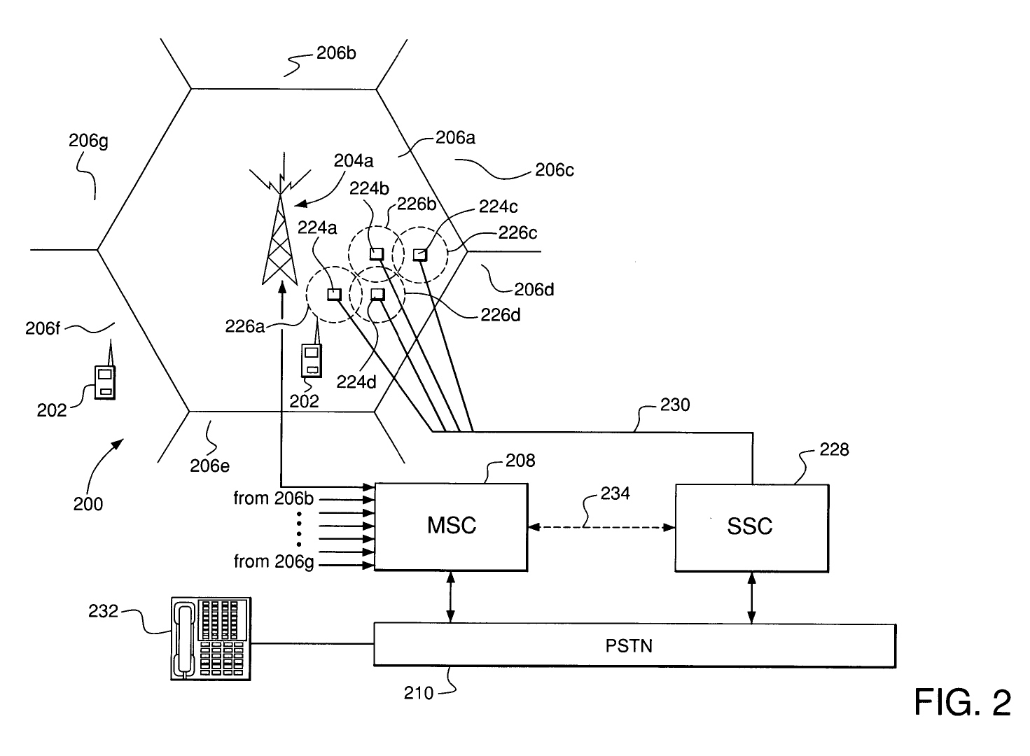

FIG. 2 shows a diagram of a wireless communication system 200 according to one embodiment of the present invention. System 200 has two superimposed communication sub-systems: (1) a primary communication sub-system comprising a plurality of cells 206 and (2) a supplemental communication sub-system comprising a plurality of cells 226. In FIG. 2, the primary and supplemental communication sub-systems are illustratively shown as having cells 206a-g and 226a-d, respectively. Cell 206a is indicated by a hexagon; cells 206b-g are shown only partially; and each of cells 226 is indicated by a circle. In a different embodiment, system 200 may have a different number of cells 206 and 226 having different shapes.

The primary communication sub-system of system 200 is analogous to the communication structure of system 100 (FIG. 1). For example, each cell 206 of system 200 is similar to cell 106 of system 100 and is served by a corresponding BS 204 connected to an MSC 208, where BS 204 and MSC 208 perform functions analogous to those of BS 104 and MSC 108, respectively. Hence, using the primary communication sub-system in system 200, an MS 202 can establish a communication link with another MS 202 or a wired telephone 232 connected to a PSTN 210 substantially as described above for MS 102 in system 100.

The supplemental communication sub-system in system 200 is novel and will be described in more detail below. Each cell 226 of the supplemental communication sub-system represents the coverage area of a corresponding supplemental transceiver unit (STU) 224, which can establish and maintain a wireless communication link with at least one MS 202 located within that coverage area. Although FIG. 2 illustratively shows four STUs 224a-d in cell 206a, in a different embodiment, system 200 may have a different number of STUs 224 distributed over any selected number of cells 206. In addition, system 200 may have STUs 224 located outside cells 206. The superposition of cells 226 may or may not form a contiguous geometric shape; different cells 226 may or may not overlap with each other; and each cell 226 may partially overlap with more than one cell 206.

In a preferred embodiment, STU 224 is an “appliance,” which has a particular primary function and is connected to a wire-line network 230. In addition, STU 224 incorporates an RF transceiver designed to establish and support a wireless link with at least one MS 202 using a suitable standard such as, for example, IS-54 (TDMA), IS-95 (CDMA), CDMA 2000, W-CDMA, GMS, AMPS, IEEE 802.11, or Blue Tooth, or a proprietary RF interface. STU 224 preferably has a coverage area (i.e., cell 226) whose linear dimension is about 10 to 100 meters. For example, depending on the environment and the power of the RF transceiver in STU 224, cell 226 could be a room in a building or a circle with the diameter of 100 m around a farmhouse.

Network 230 connects different STUs 224 to a supplemental switching center (SSC) 228. The bandwidth of network 230 depends on the primary function of STUs 224 and can be fixed or variable with time. In a preferred embodiment, SSC 228 supports the primary function of STUs 224 and, in addition, is designed to provide the functions needed to track and maintain communication via those STUs with mobile stations 202 in cells 226. The latter functions of SSC 228 are similar to those of MSC 208 and include registration, authentication, location updating, hand-offs, and call routing. Similar to MSC 208, SSC 228 serves as a gateway to PSTN 210. MSC 208 and SSC 228 maintain a service link 234, which is used to coordinate handling of transmissions for mobile stations 202 in system 200.

When MS 202 is located within cell 206, but outside of cell 226, the MS registers with MSC 208 only, e.g., as described above for system 100. Similarly, when MS 202 is located within cell 226, but outside or in a blind spot of cell 206, the MS registers with SSC 228 only. Such registration may be analogous to the registration with MSC 208. For example, if a single STU 224 detects a registration request from MS 202, then that particular STU is assigned by SSC 228 to handle transmissions for the MS. If more than one STU 224 detects the registration request, SSC 228 selects one particular STU, e.g., based on the detected signal strength, and assigns that STU to handle those transmissions.

When MS 202 is located within both cell 206 and cell 226, the MS registers with both MSC 208 and SSC 228, e.g., as described above. Then, using service link 234, MSC 208 and SSC 228 determine which of them will handle transmissions for MS 202. In one configuration, whenever MS 202 is registered with SSC 228, the SSC is selected to handle transmissions for the MS. One purpose of this transmission-handling selection is to reduce the communication burden on MSC 208 and BSs 204. In another configuration, either MSC 208 or SSC 228 may be selected, e.g., based on the respective signal strengths detected by the corresponding BS 204 and STU 224. When MS 202 moves within the coverage area of system 200, the MS may re-register and a different transmission-handling selection may be made, e.g., as described above.

The following is a brief description of representative steps taking place when MS 202 places or receives a call over system 200. When MS 202 attempts to place a call to a telephone 232 connected to PSTN 210, the MS sends a call initiation request containing the telephone number of telephone 232 to the corresponding BS 204 and/or STU 224. Depending on the selection made during the registration, either BS 204 or STU 224 acknowledges the request. For example, when SSC 228 is selected to handle transmissions for MS 202, STU 224 acknowledges the request and forwards it to the SSC, which validates the request and uses the telephone number to make a connection via PSTN 208 to telephone 232. Similarly, when MSC 208 is selected to handle transmissions for MS 202, BS 204 acknowledges the request and forwards it to the MSC, which then makes the corresponding connection via PSTN 208 to telephone 232.

To receive incoming calls, MS 202 continually scans for paging signals from the corresponding BS 204 and STU 224. Depending on the selection made during the registration, either MSC 208 or SSC 228 is configured to handle incoming calls for MS 202. For example, when SSC 228 is selected to handle transmissions for MS 202, the SSC receives via PSTN 210 a connection request from telephone 232 and forwards the request to the appropriate STU 224, which then pages the MS. After MS 202 acknowledges the page, SSC 228 routes the call from telephone 232 via that STU 224 to the MS. Similarly, when MSC 208 is selected to handle transmissions for MS 202, the MSC receives via PSTN 210 the connection request from telephone 232 and forwards the request to the appropriate BS 204, which then pages the MS. After MS 202 acknowledges the page, MSC 228 routes the call from telephone 232 via that BS 204 to the MS.

To connect two mobile stations 202 over system 200, for each of those mobile stations, it is appropriately selected, e.g., as described above, which of MSC 208 and SSC 228 will handle transmissions for the MS. Then, depending on the particular combination of transmission handling selections, calls are routed over system 200 as indicated in Table 1, where indices I and II denote, respectively, first and second mobile stations 202 and their corresponding base stations 204 and/or STUs 224. Either MS_{I}, or MS_{II} may be the calling station.

TABLE 1
Call Routing between Two Mobile Stations 202 in System 200
Transmission Handling Selection

| MS_{I} | MSC | MSC | SSC |
|---|---|---|---|
| MS_{II} | MSC | SSC | SSC |
| Call | MS_{I} - BS_{I} - MSC - | MS_{I} - BS_{I} - MSC - | MS_{I} - STU_{I} - SSC - |
| Routing | BS_{II} - MS_{II} | PSTN - SSC - STU_{II} - | STU_{II} - MS_{II} |
| | | MS_{II} | |

For example, when MS_{II} is the calling station and the transmission handling selections are made in accordance with the middle column of the corresponding section in Table 1, a call from MS_{II} to MS_{I} is routed as follows: MS_{II}-STU_{II}-SSC-PSTN-MSC-BS_{I}-MS_{I}.

Alternatively, service link 234 may be used to bypass PSTN 210 while connecting MSC 208 and SSC 228. In this configuration, handoff of MS 202 between MSC 208 and SSC 228 may be implemented similar to inter-MSC handoff in prior-art systems.

In a different embodiment, system 200 may have more than one MSC 208 and/or more than one SSC 208, each connected to PSTN 210. Such multiple MSCs and SSCs have appropriate communication links similar to service link 234, which are used for performing call routing and hand-off functions. Table 2 indicates call routing in such system, where indices I and II, in addition to denoting first and second mobile stations 202 and their respective base stations 204 and STUs 224, also denote the corresponding different MSCs and/or SSCs.

TABLE 2
Call Routing between Two Mobile Stations 202 in an Embodiment
of System 200 Having More Than One MSC 208 and/or More
Than One SSC 228

| | Transmission Handling Selection | | |
|---|---|---|---|
| MS_{I} | MSC_{I} | MSC_{I} | SSC_{I} |
| MS_{II} | MSC_{II} | SSC_{II} | SSC_{II} |
| Call | MS_{I} - BS_{I} - MSC_{I} - | MS_{I} - BS_{I} - MSC_{I} - | MS_{I} - STU_{I} - |
| Routing | PSTN - MSC_{II} - BS_{II} - | PSTN - SSC_{II} - STU_{II} - | SSC_{I} - PSTN - |
| | MS_{II} | MS_{II} | SSC_{II} - STU_{II} - |
| | | | MS_{II} |

For example, when MS, is the calling station and the transmission handling selections are made in accordance with the last column of the corresponding section in Table 2, a call from MS_{I} to MS_{II} is routed as follows: MS_{I}-STU_{I}-SSC_{I}-PSTN-SSC_{II}-STU_{II}-MS_{II}.

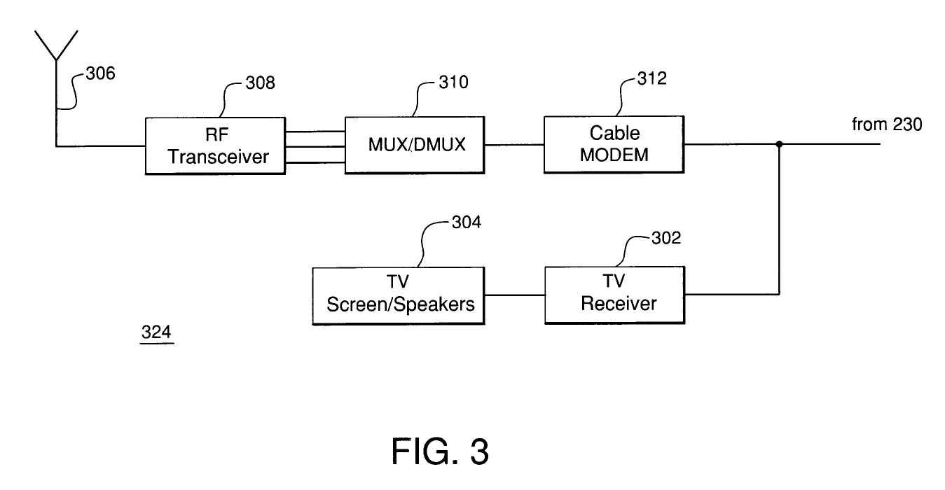

FIG. 3 shows a block diagram of an STU 324 that can be used as STU 224 in system 200 according to one embodiment of the present invention. More specifically, STU 324 is a novel TV set connected to network 230, which is a TV cable network. As such STU 324 has a conventional TV receiver 302 and a TV screen/speakers 304 whose primary function is to receive and display TV programs transmitted over network 230. In addition, STU 324 has an antenna 306 coupled to an RF transceiver (RFT) 308 designed to support a wireless communication link with N mobile stations 202, where N is an integer greater than 0. As such, transceiver 308 supports the appropriate number of communication channels in a selected frequency band. STU 328 also has an interface designed to support a wire-line communication link with SSC 228 (FIG. 2), which, in this case, is a service distribution node of the TV cable service provider. In one implementation, the interface includes a multiplexer/de-multiplexer (MUX/DMUX) 310 and a cable modem 312. Up to N data streams corresponding to the transmissions received by RFT 308 from up to N mobile stations 202 are multiplexed using MUX/DMUX 310, the output of which is applied to modem 312 coupled to network 230. Using one or more upstream cable channels assigned by SSC 228, modem 312 transfers the data over network 230 to the SSC. Similarly, using one or more downstream cable channels assigned by SSC 228, modem 312 receives from the SSC signals corresponding to transmissions directed to the up to N mobile stations. The data stream generated by modem 312 is appropriately de-multiplexed into up to N individual data streams using MUX/DMUX 310, each individual data stream corresponding to a particular MS 202. These up to N data streams are then applied to RFT 308 for wireless transmission to the mobile stations.

Since TV cable service is typically available inside buildings where blind spots often occur, system 200 configured with STUs 324 may advantageously be able to provide service to mobile stations therein, thereby reducing the area affected by blind spots compared to that in prior-art wireless communication system 100. In addition, due to the presence of the supplemental communication sub-system, system 200 has additional communication capacity, which may be utilized to improve performance, for example, when call volume processed by a particular cell of the primary communication sub-system approaches the full capacity of the corresponding BS.

In alternative embodiments, the supplemental communication sub-system in system 200 may be based on different STU devices. For example, in one embodiment, STU 224 is a stationary radio set connected to a radio programming distribution network 230 and SSC 228 is a distribution node of the corresponding service provider. In another embodiment, STU 224 is a computer, network 230 is a local area network connected to the Internet, and SSC 228 is a node of an Internet service provider.

While this invention has been described with reference to illustrative embodiments, this description is not intended to be construed in a limiting sense. Although system 200 was described in reference to voice communications, it can also be configured to transmit data. The standard used for implementing a wireless communication link between STU 224 and MS 202 may or may not have a quality of service (QoS) provision. SSC 228 may not be directly connected to PSTN 210 and use link 234 to connect to the PSTN via MSC 208. Various modifications of the described embodiments, as well as other embodiments of the invention, which are apparent to persons skilled in the art to which the invention pertains are deemed to lie within the principle and scope of the invention as expressed in the following claims.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

1. A wireless communication system for providing service to mobile stations, the system comprising a supplemental communication sub-system including one or more supplemental transceiver units (STUs) connected to a supplemental switching center (SSC), wherein:
the SSC has access to a public switched telephone network (PSTN) and is adapted to control operation of the one or more STUs; and
each STU has a primary function and is further adapted to support (i) a wireless communication link with at least one mobile station and (ii) a wire-line communication link with the SSC.

2. The system of claim 1, wherein the SSC is directly connected to the PSTN.

3. The system of claim 1, wherein the supplemental communication sub-system is configured to transmit voice communication signals.

4. The system of claim 1, wherein the SSC is adapted to support the primary function.

5. The system of claim 1, wherein each STU comprises:
a radio-frequency transceiver (RFT) adapted to support the wireless communication link with the at least one mobile station; and
an interface adapted to support the wire-line communication link with the SSC.

6. The system of claim 5, wherein:
each STU further comprises a TV receiver and a display screen;
the primary function is to receive and display TV programs;
the SSC is a distribution node of a cable service provider; and
the interface comprises a cable modem.

7. The system of claim 1, further comprising a primary communication sub-system including a plurality of base stations (BSs) connected to a mobile services switching center (MSC), wherein:
the MSC is connected to the PSTN and is adapted to control operation of the BSs; and
each BS is adapted to support (i) a wireless communication link with a plurality of mobile stations and (ii) a wire-line communication link with the MSC.

8. The system of claim 7, wherein the SSC is connected to the PSTN through the MSC.

9. The system of claim 7, wherein the MSC and the SSC have a service link to coordinate transmissions for a selected mobile station.

10. The system of claim 7, wherein, when a mobile station has wireless links with a corresponding BS and a corresponding STU, the supplemental communication sub-system is selected to carry transmissions for said mobile station.

11. The system of claim 7, wherein, when a mobile station has wireless links with a corresponding BS and a corresponding STU, one of the primary and supplemental communication sub-systems is selected to carry transmissions for said mobile station based on signal strengths at the corresponding BS and STU.

12. Apparatus for use in a wireless communication system providing service to mobile stations, the apparatus comprising:
a radio-frequency transceiver (RFT) adapted to support a wireless communication link with at least one mobile station; and
an interface adapted to support a wire-line communication link with a supplemental switching center (SSC) having access to a public switched telephone network (PSTN), wherein:
the apparatus has a primary function and is adapted to be controlled by the SSC; and
the wireless communication system includes the SSC.

13. The apparatus of claim 12, wherein the apparatus is adapted to transmit voice communication signals.

14. The apparatus of claim 12, wherein the SSC is adapted to support the primary function.

15. The apparatus of claim 12, wherein:
the apparatus further comprises a TV receiver and a display screen;
the primary function is to receive and display TV programs;
the SSC is a distribution node of a cable service provider; and
the interface comprises a cable modem.

16. The apparatus of claim 12, wherein:
the wireless communication system comprises a supplemental communication sub-system including one or more supplemental transceiver units (STUs) connected to the SSC; and
the apparatus is one of the STUs.

17. The apparatus of claim 12, wherein the SSC is adapted to support the primary function.

18. A method of transmitting communication signals corresponding to a mobile station in a wireless communication system, the method comprising:
(A) selecting one of a primary communication sub-system and a supplemental communication sub-system to carry the communication signals for the mobile station; and
(B) transmitting the communication signals for the mobile station via the selected communication sub-system, wherein:
the wireless communication system includes the primary and supplemental communication sub-systems;
the supplemental communication sub-system includes one or more supplemental transceiver units (STUs) connected to a supplemental switching center (SSC);
the SSC has access to a public switched telephone network (PSTN) and is adapted to control operation of the one or more STUs; and
each STU has a primary function and is further adapted to support (i) a wireless communication link with at least one mobile station and (ii) a wire-line communication link with the SSc.

19. The system of claim 18, wherein the SSC is directly connected to the PSTN.

20. The method of claim 18, wherein the SSC is adapted to support the primary function.

21. The method of claim 18, wherein:
the primary communication sub-system includes a plurality of base stations (BSs) connected to a mobile services switching center (MSC);
the MSC is connected to the PSTN and is adapted to control operation of the BSs; and
each BS is adapted to support (i) a wireless communication link with a plurality of mobile stations and (ii) a wire-line communication link with the MSC.

22. The method of claim 21, further comprising maintaining a service link between the MSC and the SSC.

23. The method of claim 21, wherein the SSC is connected to the PSTN through the MSC.

24. The method of claim 21, wherein step (A) comprises at least one of:
(A1) assigning a BS to the selected mobile station; and
(A2) assigning an STU to the selected mobile station.

25. The method of claim 24, wherein step (A) comprises making the selection based on detected signal strengths at the assigned BS and STU.

26. The method of claim 18, wherein each STU comprises:
a radio-frequency transceiver (RFT) adapted to support the wireless communication link with the at least one mobile station; and
an interface adapted to support the wire-line communication link with the SSC.

27. The method of claim 26, wherein:
each STU further comprises a TV receiver and a display screen;
the primary function is to receive and display TV programs;
the SSC is a distribution node of a cable service provider; and
the interface comprises a cable modem.
